(19) United States
(12) Patent Application Publication
(10) Pub. No.: US 2017/0213163 A1
(43) Pub. Date: Jul. 27, 2017

(54) LODGING FACILITY MANAGEMENT SYSTEM AND METHOD FOR ANONYMOUS CHECK-IN

(71) Applicant: Chiukit Cheung, West Covina, CA (US)

(72) Inventor: Chiukit Cheung, West Covina, CA (US)

(21) Appl. No.: 15/406,414

(22) Filed: Jan. 13, 2017

Related U.S. Application Data
(60) Provisional application No. 62/281,654, filed on Jan. 21, 2016.

(51) Int. Cl. G06Q 10/02; G06Q 20/18

(52) U.S. Cl. CPC G06Q 10/02; G06Q 20/18

(57) ABSTRACT

A system and method for remote and anonymous check-in at a lodging facility enables a guest to check in to the lodging facility by remotely making a reservation to stay at the lodging facility for a predetermined duration, and anonymously entering and leaving the room. The duration of stay may include only a few hours to increase turnover for the lodging facility and flexibility to the guest. The guest selects a themed room. The guest remotely pays for the themed room through a software application on a smart phone. The guest anonymously checks in to the lodging facility. A kiosk provides an access mechanism for the selected themed room to the guest. The guest anonymously enters the themed room through a discrete route, such as a covered garage. The guest anonymously returns the access mechanism for the themed room, and remotely checks out from the lodging facility.

### CROSS REFERENCE OF RELATED APPLICATIONS

This application claims the benefits of U.S. provisional application No. 62281654, filed Jan. 21, 2016 and entitled SYSTEM AND METHOD FOR REMOTE AND ANONYMOUS CHECK-IN AT A LODGING FACILITY, which provisional application is incorporated by reference herein in its entirety.

### FIELD OF THE INVENTION

The present invention relates generally to a lodging facility management system and method for remote and anonymous check-in at a lodging facility. More so, a system and method enables a guest to remotely and anonymously check in to a lodging facility by remotely making a reservation to stay at the lodging facility for a predetermined duration; selecting a themed room from a plurality of themed rooms; remotely paying for the themed room; anonymously checking in to the lodging facility; anonymously receiving an access mechanism for the selected themed room; anonymously entering the themed room through a discrete route; anonymously returning the access mechanism for the themed room; and remotely checking out from the lodging facility.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a lodging facility, such as a motel, hotel, or lodge is an establishment that provides lodging paid on a short-term basis. Such lodging facilities may range from a modest-quality mattress in a small room to large suites with bigger, higher-quality beds, a dresser, a fridge and other kitchen facilities, upholstered chairs, a flat screen television and in suite bathrooms. Small, lower-priced hotels may offer only the most basic guest services and facilities.

It is known that the Internet has enabled users to quickly and easily make hotel reservations from anywhere in the world, as long as users have an Internet connection and a suitable browser. Online reservation making has largely replaced lengthy (and potentially expensive) telephone calls or working through a costly travel agency.

Generally, checking-in when arriving at the lodging facility is time consuming. In addition, it is also unsafe, as another person might get access to your room when using a false identity. Often, a hotel reservation system includes hotel rooms having combination locks electronically set so as to be openable by any one of a plurality of combination codes whenever the combination code is inputted. Additionally, keys or cards are used to access the door.

Unfortunately, the process for checking in to a hotel has largely remained unchanged. A guest must arrive at the hotel, wait in line to be served by a hotel employee, provide information to the hotel employee regarding the guest's room preferences and payment, wait until an available room is identified and assigned to that guest, and receive a key or means of unlocking the room.

Other proposals have involved checking in to lodging facilities. The problem with these check-in processes is that they are not very anonymous, and they do not provide the guest with efficient check-in means through a software application. Also, the check-in must be manned by a person, which increases labor costs. Even though the above cited lodging facility check-in processes meet some of the needs of the market, a system and method for remote and anonymous check-in at a lodging facility enables a guest to check in to the lodging facility by remotely making a reservation to stay at the lodging facility for a predetermined duration, and anonymously entering and leaving the room is still desired.

### SUMMARY

Illustrative embodiments of the disclosure are generally directed to a lodging facility management system and method for remote and anonymous check-in at a lodging facility. The system and method enables a guest to check in to the lodging facility by remotely making a reservation to stay at the lodging facility for a predetermined duration, and anonymously entering and leaving the room. The duration of stay may include only a few hours to increase turnover for the lodging facility and flexibility to the guest. The guest selects a themed room. The guest remotely pays for the themed room through a software application on a smart phone. The guest anonymously checks in to the lodging facility. A kiosk provides an access mechanism for the selected themed room to the guest. The guest anonymously enters the themed room through a discrete route, such as a covered garage. The guest anonymously returns the access mechanism for the themed room, and remotely checks out from the lodging facility.

In one aspect, a method for anonymous check-in at a lodging facility, comprises:

remotely making a reservation to a lodging facility;

selecting a themed room from a plurality of themed rooms in the lodging facility;

remotely paying for the themed room;

anonymously checking in to the lodging facility;

anonymously receiving an access mechanism for the selected themed room;

anonymously entering the themed room through a discrete route;

anonymously returning the access mechanism for the themed room; and

remotely checking out from the lodging facility.

In another aspect, the lodging facility includes at least one member selected from the group consisting of: a motel, an inn, a hostel, a resort, a single building, a multiple building complex, and any lodging establishment having rooms available for stay.

In another aspect, the themed room comprises a hotel room with a theme.

In another aspect, the step of anonymously checking in to the lodging facility comprises checking in through a software application on a smart phone.

In another aspect, the access mechanism includes at least one member selected from the group consisting of: a key, an access card, and a code.

In another aspect, the discrete route comprises a covered garage.

In another aspect, the method further comprises a kiosk, whereby check-in is initiated.

In another aspect, the kiosk is configured to enable check-in, receive the access mechanism, and check-out.

In another aspect, the kiosk includes at least one member selected from the group consisting of: a robot, a chatbot, a virtual person, computer screen, a vending machine, and a hotel clerk behind a one-way glass.

In another aspect, the step of remotely making a reservation to a lodging facility is operable in person, or online, or with a software application.

In another aspect, the step of anonymously entering the themed room through a discrete route is operable to check in from a drive through for a vehicle.

In another aspect, the step of remotely checking out from the lodging facility is operable with the drive through for the vehicle.

One objective of the present invention is to enable a guest to check into a lodging facility anonymously.

Another objective is to provide a more efficient method for a travelling guest to make lodging reservations, to provide a themed room, and to control access to that room.

Another objective is to enable remote registration and payment for the themed room.

Another objective is to enable the lodging facility to have greater turnover of guests by allowing the guests to check in for a few hours.

Another objective is to utilize automatic check-out that does require the guest to line-up at the front-desk, thus again saving time for the traveler, and reducing staff requirements for the hotel.

Another objective is to provide a method for making a lodging reservation, and for improved check-in.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram for an exemplary system for remote and anonymous check-in to a lodging facility, in accordance with an embodiment of the present invention;

FIG. 2 illustrates a check-in page displaying check-in information to provide information to a guest about a selected themed room and check-in time, in accordance with an embodiment of the present invention;

FIG. 3 illustrates a flowchart for an exemplary method for remote and anonymous check-in to a lodging facility, in accordance with an embodiment of the present invention; and

FIG. 4 illustrates a flowchart for an alternative method for remote and anonymous check-in to a lodging facility, in accordance with an embodiment of the present invention.

Like reference numerals refer to like parts throughout the various views of the drawings.

### DETAILED DESCRIPTION OF THE INVENTION

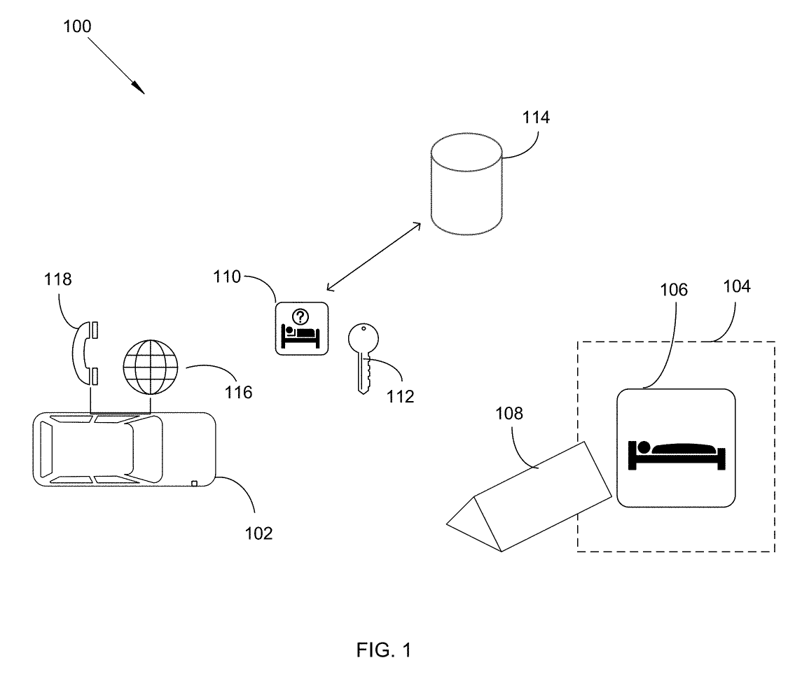

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-4, a lodging facility management system 100 and method 200 for remote and anonymous check-in at a lodging facility 104. The lodging facility management system, hereafter “system”, and method of anonymous check-in enables a guest 102 to remotely and anonymously check in to a lodging facility 104 for a predetermined duration. The entire period of checking in to the lodging facility 104, until finally checking out of the lodging facility 104 may be accomplished anonymously by the guest 102. In this manner, whereby speaking with or being visually accessible to other parties is not necessary.

The system 100 and method 200 also provides greater turn over, i.e., profits, to the lodging facility 104 since the selected predetermined duration of stay by the guest 102 may be for only a few hours. For example, an automated kiosk 110 may be employed to minimize labor costs to the lodging facility. The lodging facility 104 may also provide a plurality of themed rooms 106 for selection by the guest 102, such that the guest 102 receives greater variety and entertainment during the duration of the stay.

FIG. 1 illustrates an exemplary system 100 for remote and anonymous check-in at a lodging facility 104. The system 100 operates around a lodging facility 104. In some embodiments, the lodging facility 104 may include any lodging establishment having rooms available for stay, including without limitation a motel, inn, hostel, resort, single building, and multiple building complex.

The system 100 is configured to allow a guest 102 to remotely make a reservation to stay at a lodging facility 104 for a predetermined duration. The remote reservation may be made through a software application 116 that is downloadable on a communication device 118, such as a smart phone. However, the remote reservation may also be made by computer, email, by text, by phone, and by mail.

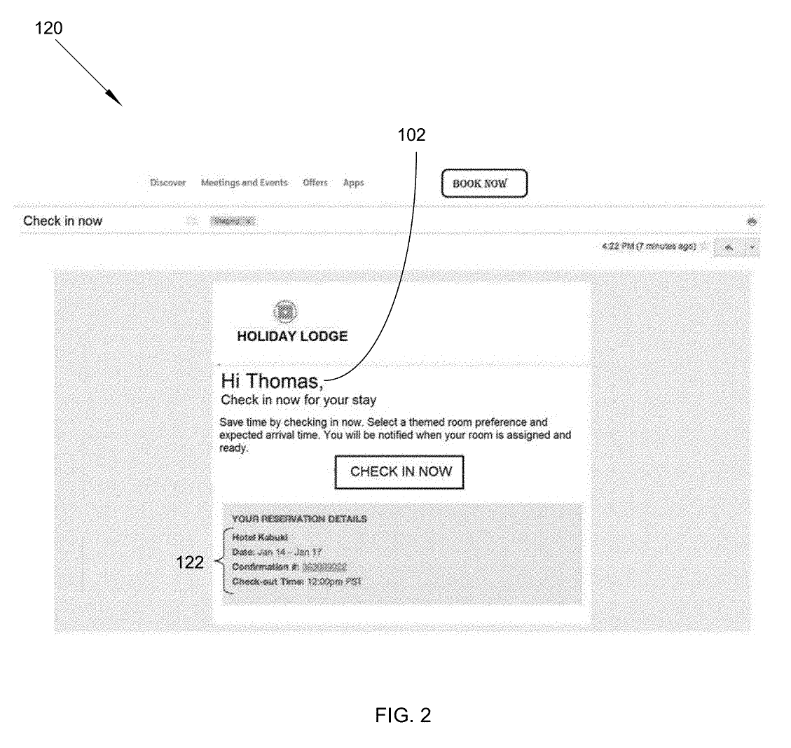

As illustrated in FIG. 2, the guest 102 may check in to the lodge and select the themed room 106 through a check-in page 120 that displays on the software application 116. The check-in page 120 includes check-in information 122 that helps the guest 102 understand about the selected themed room 106 and the check-in time. A confirmation code may also be provided to further expedite the check-in process for the guest 102.

In one exemplary use, the system 100 sends, to a database 114, or computing device of a prospective guest, an electronic notification that indicates that the prospective guest 102 can check-in online instead of having to wait in line at the lodging facility 104. A series of check-in pages are presented to the prospective guest 102, such as a page 120 to allow the prospective guest 102 to specify room 106 preferences and other requests, a page to allow the prospective guest to accept an upgrade offer, a page to confirm payment, and/or a page that shows a room assignment.

Those skilled in the art will recognize that by providing greater amounts of options, such as these, the guest is provided with a more enjoyable, convenient stay at the lodging facility 104. For example, by allowing the guest 102 to have shorter durations of stay, the lodging facility 104 increases turnover, and thereby profitability. Also, the guest 102 benefits by paying a lesser amount for a shorter stay. In this manner, paying for the themed room 106 is flexible, as the guest 102 may require a stay for periods shorter than a night.

In one example of a short duration of stay, room charges are based on 3 hour periods, with full day options available. Thus, the guest 102 is not bound by the rigid check-in and check-out times of traditional motels and hotels, since the guest 102 only has to pay for a few hours, rather than a full night.

In one embodiment, the lodging facility 104 utilizes a database 114 for storing information about the guest 102 when the guest makes the reservation. The information about the guest 102 may include, without limitation, contact information, date and time of arrival, the predetermine duration, the type of themed room 106, the number of guest occupants, special requests, and the like. The database 114 may be accessible through a website for access by administrators, employees of the lodging facility 104, and the guest 102.

In yet another embodiment, the lodging facility 104 utilizes a host server adapted to host a web-site for allowing the guest 102 to create an account. The host server includes the above mentioned database 114 for storing the user information. In one possible embodiment, the host server is adapted to allow a guest 102 with a pre-stored account, to select a themed room 106, and to make a lodging reservation for the predetermined duration; thereby creating reservation data. The host server may also be adapted for transmitting the reservation data to a hotel management server of the lodging facility 104.

In one embodiment, the lodging facility 104 utilizes a plurality of themed rooms. The system 100 also allows the guest 102 to select a themed room 106 from the plurality of themed rooms, including a wide variety of themed room 106 and accommodations. In one embodiment, the themed room 106 can be outfitted with various themes, styles, and decorations. In this manner, the guest 102 does not stay in a generic, mundane room 106.

As used here, a room is any distinguishable space within a structure. The room is separated from other spaces or passageways by interior walls; moreover, it is separated from outdoor areas by an exterior wall, sometimes with a door. The theme of the themed room 106 may cover a unifying subject or idea of the type of visual work. For example, a safari themed room may include mounted skins of African animals. A space themed room may include star and moon images on wallpaper and dark lighting.

After selecting the predetermined duration of stay at the lodging facility 104, and selecting he themed room 106, the guest 102 pays for the themed room 106. The payment may also be made through the software application on the smart phone or computer, in much the same means as the reservation was made. However in other embodiments, the payment may be made by mail, phone, or courier. In some embodiments, the guest 102 may use password coding, rather than providing a name to make a payment in a preset account.

After selecting the themed room 106, the guest 102 may anonymously check in to the lodging facility 104. This anonymous check in forms the core novelty of the system 100, since the guest 102 may not want to be seen or identified upon arrival at the lodging facility 104.

Those skilled in the art will recognize that the current model for motels requires customers to book online, over the phone, or in person. The guest usually arrives at the motel, parks a vehicle, and enters a lobby of the motel to check in and receive the room keys. The customer must then walk or drive to the motel room. Furthermore, motel rooms are charged on a nightly basis with a single night being the minimum length of stay. The anonymous check-in provided by the system 100 helps the guest 102 avoid this overt check-in process.

In one embodiment, the guest 102 anonymously checks in at a kiosk 110. The kiosk 110 may include, without limitation, a robot, a chatbot, a virtual person, computer screen, a vending machine, and a hotel clerk behind a one-way glass. The guest 102 may not have to leave a vehicle to access the kiosk 110. The guest 102 may contact the kiosk 110 for remote check-in prior to arriving at the lodging facility 104.

Thus, it is an advantage of such a system 100 that it provides automatic check-in functionality in an impersonal kiosk. This may save costs to the lodging facility 104 for not having to constantly staff the front-desk, for receiving and providing keys, even late at night. In addition, this may save considerable time to the frequently traveling guest 102, for not having to line-up at the front desk when arriving at the lodging facility 104.

However, in one alternative embodiment, the kiosk 110 at the automatic check-in can still be supplemented by person-assisted check-in at the front-desk, if so desired. Thus, a guest 102 who does not wish to use the automatic check-in system 100, may still go to the front-desk, to be checked-in manually into a hotel server system, and may be assigned the themed room 106 manually. After check-in, the guest 102 may or may not use the kiosk 110 for retrieving an access mechanism 112, such as a key, to the room 106.

Looking again at FIG. 1, the guest 102 receives an access mechanism 112 to enter the themed room 106 during check-in. The access mechanism 112 may include, without limitation, a key, a data card, and a code. Similar to the aforementioned anonymous check-in, the access mechanism 112 is obtained discretely, such that the guest 102 anonymously receives access mechanism 112 for the selected themed room 106 from the kiosk 110, or from a dispensing mechanism operatively connected to the kiosk 110. In one embodiment, the kiosk 110 includes a dispenser or vendor to provide the access mechanism 112.

Upon receiving the access mechanism 112, the guest 102 may then proceed to the themed room 106 anonymously through a discrete route 108. The discrete route 108 continues the idea of total anonymity for the guest 102 by allowing the guest 102 to enter the themed room 106 without being visually detected. In one embodiment, the discrete route 108 comprises a private garage that is connected to the themed room 106. However in other embodiments, the discrete access may include, without limitation, a tunnel, an elevator, and a secret passage wall.

In one exemplary use of the discrete route 108, the guest 102 goes straight from the check-in kiosk 110 to the themed room 106 without having to dismount the vehicle at any time. Those skilled in the art will recognize that this anonymous access to the themed room 106 through the discrete route 108 allows the guest 102 to reduce the risk of being spotted or pestered by paparazzi or other individuals.

After the predetermined duration in the themed room 106 has expired, the guest 102 anonymously leaves the themed room 106 through the discrete route 108 and returns the access mechanism 112 at the kiosk 110. The guest 102 may leave the themed room 106 through the same discrete route 108 used to enter the themed room 106. After returning the access mechanism 112, the guest 102 remotely checks out of the lodging facility 104 through the same means used to check in.

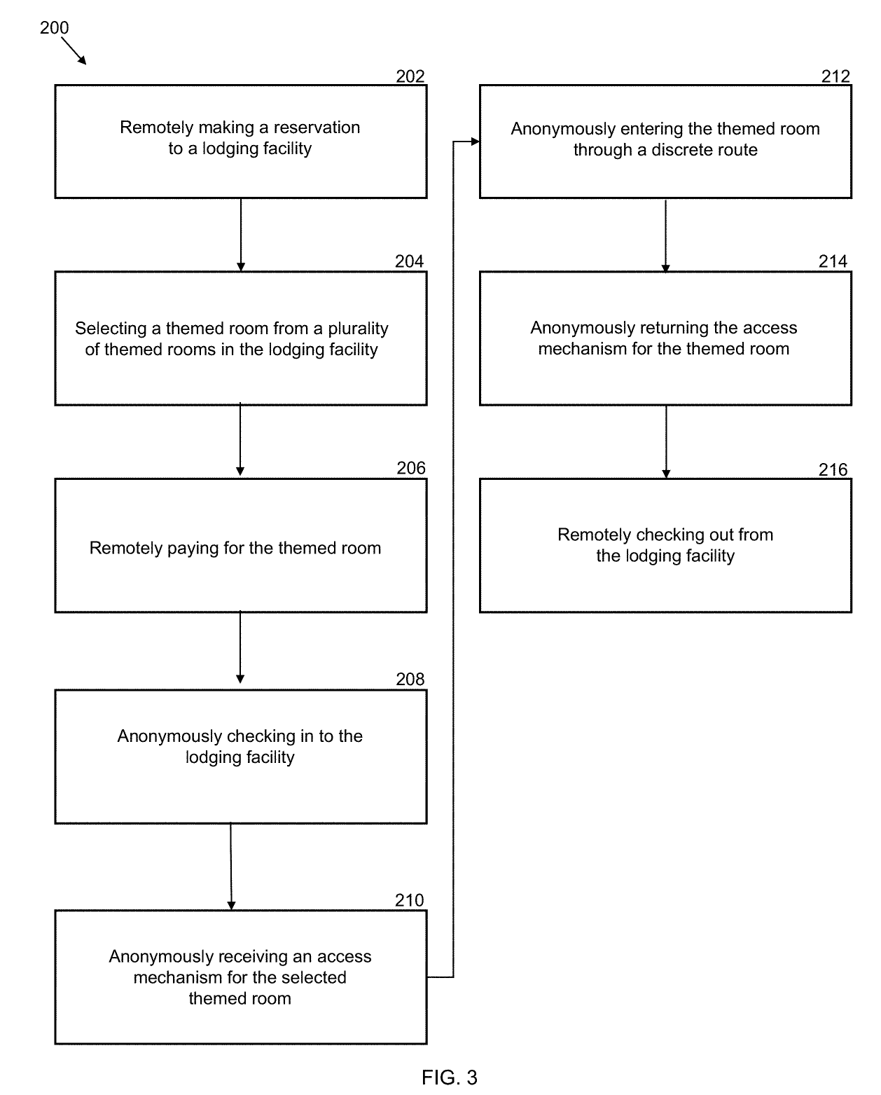

FIG. 3 illustrates a flowchart for an exemplary method 200 for remote and anonymous check-in to a lodging facility 104. In some embodiments, the method 200 enables a guest 102 to remotely and anonymously check in to a lodging facility 104 for a predetermined duration. The entire process of checking in to the lodging facility 104, until finally checking out of the lodging facility 104 may be accomplished anonymously for the guest 102, whereby speaking with or being visually accessible to other parties is not necessary.

Furthermore, the method 200 also provides greater turn over to the lodging facility 104 since the selected predetermined duration of stay by the guest 102 may be for only a few hours. The lodging facility 104 may also provide a plurality of themed rooms 106 for selection by the guest 102, such that the guest 102 receives greater variety and entertainment during the duration of the stay.

An initial Step 202 comprises remotely making a reservation to a lodging facility 104. The method 200 allows the guest 102 to remotely make a reservation to stay at a lodging facility 104 for a predetermined duration. The remote reservation may be made through a software application that is downloadable on a smart phone. The reservation may7 also be made in person, online, or through an app. A Step 204 of the method 200 may further include selecting a themed room 106 from a plurality of themed rooms in the lodging facility 104. In one embodiment, the lodging facility 104 utilizes a plurality of themed rooms.

A Step 206 comprises remotely paying for the themed room 106. The system 100 also allows the guest 102 to select a themed room 106. The system 100 enables the guest 102 to select the themed room 106 from a plurality of themed rooms 106, including a wide variety of themed rooms 106 and accommodations. The method 200 may further include a Step 208 of anonymously checking in to the lodging facility 104.

The guest 102 may check in at an unmanned kiosk 110. The guest 102 may pass through a vehicle drive through to check in. A Step 210 includes anonymously receiving an access mechanism 112 for the selected themed room 106. The guest 102 receives an access mechanism 112 to enter the themed room 106 during check-in. The access mechanism 112 may include, without limitation, a key, a data card, and a code.

A Step 212 may include anonymously entering the themed room 106 through a discrete route 108. Upon receiving the access mechanism 112, the guest 102 may then proceed to the themed room 106 anonymously through a discrete route 108. The discrete route 108 continues the idea of total anonymity for the guest 102 by allowing the guest 102 to enter the themed room 106 without being visually detected. In one embodiment, the discrete route 108 comprises a private garage that is connected to the themed room 106.

A Step 214 includes anonymously returning the access mechanism 112 for the themed room 106. A final Step 216 comprises remotely checking out from the lodging facility 104. The guest 102 may check out at the unmanned kiosk 110. The guest 102 may pass through a vehicle drive through to check out. After the predetermined duration in the themed room 106 has expired, the guest 102 anonymously returns the access mechanism 112 for the themed room 106 at the kiosk 110.

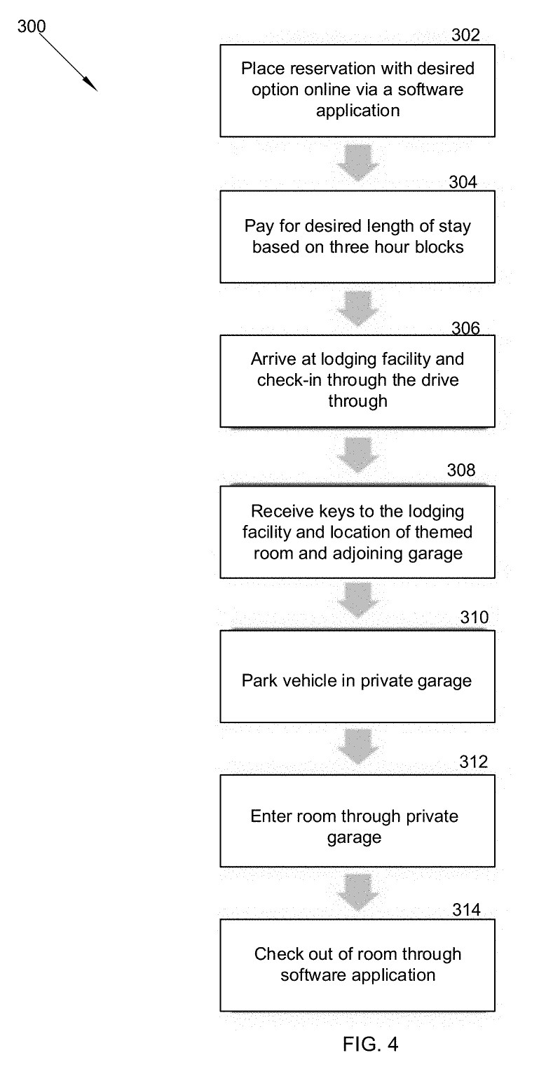

FIG. 4 illustrates a flowchart for an alternative method 300 for remote and anonymous check-in to a lodging facility 104. The alternative method 300 includes an initial Step 302 to place reservation with desired options online or via the software application. A Step 304 requires to pay for desired length of stay at the lodging facility based on 3 hour blocks. A Step 306 comprises arriving at the lodging facility and checking in through a drive through. The method 300 may also include a Step 308 of receiving keys to the themed room and location of room and adjoining garage. A Step 310 comprises parking a vehicle in the private garage and closing garage door. In some embodiments, a Step 312 involves entering themed room through the private garage. A final Step 314 includes checking out of the lodging facility via the software application.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A method for anonymous check-in at a lodging facility, the method comprising:
remotely making a reservation to a lodging facility;
selecting a themed room from a plurality of themed rooms in the lodging facility;
remotely paying for the themed room;
anonymously checking in to the lodging facility;
anonymously receiving an access mechanism for the selected themed room;
anonymously entering the themed room through a discrete route;
anonymously returning the access mechanism for the themed room; and
remotely checking out from the lodging facility.

2. The method of claim 1, wherein the lodging facility includes at least one member selected from the group consisting of: a motel, an inn, a hostel, a resort, a single building, a multiple building complex, and any lodging establishment having rooms available for stay.

3. The method of claim 1, wherein the themed room comprises a hotel room with a theme.

4. The method of claim 1, wherein the step of anonymously checking in to the lodging facility comprises checking in through a software application on a smart phone.

5. The method of claim 1, wherein the access mechanism includes at least one member selected from the group consisting of: a key, an access card, and a code.

6. The method of claim 1, wherein the discrete route comprises a covered garage. The method of claim 1, further including a kiosk.

8. The method of claim 7, wherein the kiosk is configured to enable check-in, receive the access mechanism, and check-out.

9. The method of claim 8, wherein the kiosk includes at least one of the following: a robot, a chatbot, a virtual person, computer screen, a vending machine, and a hotel clerk behind a one-way glass.

10. The method of claim 1, wherein the step of remotely making a reservation to a lodging facility is operable in person, or online, or with a software application.

11. The method of claim 1, wherein the step of anonymously entering the themed room through a discrete route is operable from a drive through for a vehicle.

12. The method of claim 11, wherein the step of remotely checking out from the lodging facility is operable from the drive through for the vehicle.

13. A system for anonymous check-in at a lodging facility, the system comprising:
a lodging facility configured to enable lodging of a guest, the lodging facility comprising a plurality of themed rooms, at least one of which is selected by the guest;
a software application that is downloadable on a communication device, the software application configured to enable the guest to remotely check in to the lodging facility;
a check-in page configured to display check-in information about the selected themed room;
a database configured to store information about the guest when the guest makes the reservation;
a kiosk configured to enable checking in to the lodging facility;
an access mechanism configured to enable access to at least one of the plurality of themed rooms in the lodging facility, whereby the access mechanism is obtained by the guest at the kiosk; and
a discrete route configured to enable anonymous access to and from the lodging facility.

14. A method for anonymous check-in at a lodging facility, the method consisting of:
remotely making a reservation to a lodging facility through a software application that is downloadable on a communication device, the lodging facility including at least one of the following: a motel, a hotel, an inn, a hostel, a resort, a single building, and a multiple building complex;
selecting a themed room from a plurality of themed rooms in the lodging facility;
remotely paying for the themed room through the software application;
anonymously checking in to the lodging facility through a kiosk, the kiosk including at least one of the following: a robot, a chatbot, a virtual person, computer screen, a vending machine, and a hotel clerk behind a one-way glass.;
anonymously receiving an access mechanism for the selected themed room;
anonymously entering the themed room through a discrete route;
anonymously returning the access mechanism for the themed room to the kiosk; and
remotely checking out from the lodging facility through the discrete route.

15. The method of claim 14, wherein the lodging facility includes at least one member selected from the group consisting of: a motel, an inn, a hostel, a resort, a single building, a multiple building complex, and any lodging establishment having rooms available for stay.

16. The method of claim 14, wherein the themed room comprises a hotel room with a theme.

17. The method of claim 14, wherein the access mechanism includes at least one member selected from the group consisting of: a key, an access card, and a code.

18. The method of claim 14, wherein the discrete route comprises a covered garage.

19. The method of claim 14, wherein the step of anonymously entering the themed room through a discrete route is operable from a drive through for a vehicle.

20. The method of claim 19, wherein the step of remotely checking out from the lodging facility is operable from the drive through for the vehicle.
